(19) United States
(12) Patent Application Publication
(10) Pub. No.: US 2025/0123368 A1
(43) Pub. Date: Apr. 17, 2025

(54) LIGHT EMISSION MODULE AND WIDE ANGLE SCANNING SYSTEM

(71) Applicant: Industrial Technology Research Institute, Hsinchu (TW)

(72) Inventors: CHIA-YU HU, Tainan City (TW); CHIH-CHUN CHEN, Kaohsiung City (TW); YI-CHI LEE, Taichung City (TW); JI-BIN HORNG, Tainan City (TW)

(21) Appl. No.: 18/520,084

(22) Filed: Nov. 27, 2023

(30) Foreign Application Priority Data
Oct. 13, 2023 (TW) 112139163

(51) Int. Cl. G01S 7/481

(52) U.S. Cl. CPC G01S 7/4817; G01S 7/4818

(57) ABSTRACT

A light emission module includes a laser source, a beam steering element, a focusing lens set, an imaging fiber bundle set, and expansion lens sets. The beam steering element splits a received laser beam into at least two laser beams to the focusing lens set. The imaging fiber bundle set includes a receiving element and branch elements, which the branch elements are individually connected to the receiving element, distributed disposing, and oriented to individual desired scanning directions. The focusing lens set is disposed between the beam steering element and the receiving element. The at least two laser beams are focused on the receiving element and emitted through one of the branch elements. The expansion lens sets, disposed individually corresponding to the branch elements, receives the laser beam emitted from the branch elements and further controls the laser beam to have a spread angle and an expanding angle.

### CROSS REFERENCE TO RELATED APPLICATION

This application claims the benefits of Taiwan application Serial No. 112139163, filed on Oct. 13, 2023, the disclosures of which are incorporated by references herein in its entirety.

### TECHNICAL FIELD

The present disclosure relates in general to a light emission module and wide angle scanning system.

### BACKGROUND

The light detection and ranging (also known as LiDAR) system architecture uses a laser source with a scanning component (with or without rotating parts) to achieve laser beam scanning, and thus obtain information of a relative distance to an object to be measured to achieve a purpose of object detection and ranging.

A viewing angle of the LiDAR is an important specification for LiDAR manufacturers. Generally, a typical mechanical LiDAR has a mechanical rotation shaft to perform a 360-degree horizontal beam scanning. However, due to a larger size, the mechanical LiDAR is vulnerable to mechanical shocks. On the other hand, in a semi-solid or solid LiDAR system such as a micro electromechanical system (MEMS), an optical phase array (OPA) system or a flash LiDAR system, wide-angle lenses are utilized and supplemented by splicing to achieve a wide-angle vision field (for example, a vision between 120° and 180° horizontal scanning angles). However, the process of integrating multiple sets of LiDAR systems is pretty difficult. In addition, though a plurality of semi-solid or solid LiDAR systems can be integrated to achieve the 360-degree horizontal scanning, yet such a method would be costly and may cause difficulty in the following image stitching and data fusion.

Therefore, how to overcome the aforesaid shortcomings in the existing LiDAR systems, and to further provide a satisfied LiDAR system, is definitely urgent to the skill in the art.

### SUMMARY

An object of the present disclosure is to provide a light emission module and a wide angle scanning system that can overcome the aforesaid technical shortcomings in the LiDAR technology, and provide a wider viewing angle and also an adjustable scanned range.

In one embodiment of this disclosure, a light emission module includes a laser source, a beam steering element, a focusing lens set, an imaging fiber bundle set, and a plurality of expansion lens set. The laser source is configured for emitting a laser beam. The beam steering element is configured for receiving the laser beam and further for splitting the laser beam into at least two laser beams. The focusing lens set is configured for receiving the at least two laser beams split from the beam steering element. The imaging fiber bundle set includes a receiving element and a plurality of branch elements, wherein the plurality of branch elements are individually connected to the receiving element, distributed disposing, and oriented to individual desired scanning directions. The focusing lens set is disposed between the beam steering element and the receiving element. The at least two laser beams are focused on the receiving element by the focusing lens set and emitted through one of the plurality of branch elements. The plurality of expansion lens sets are disposed individually corresponding to the plurality of branch elements and configured for receiving the laser beam emitted from one of the plurality of branch elements and further controlling the laser beam correspondingly to have a spread angle and an expanding angle.

In another embodiment of this disclosure, a wide angle scanning system, applied to scan an object, includes a light emission module and at least one beam receiving module. The light emission module includes a laser source, a beam steering element, a focusing lens set, an imaging fiber bundle set, and a plurality of expansion lens set. The laser source is configured for emitting a laser beam. The beam steering element is configured for receiving the laser beam and further for splitting the laser beam into at least two laser beams. The focusing lens set is configured for receiving the at least two laser beams split from the beam steering element. The imaging fiber bundle set includes a receiving element and a plurality of branch elements, wherein the plurality of branch elements are individually connected to the receiving element, distributed disposing, and oriented to individual desired scanning directions. The focusing lens set is disposed between the beam steering element and the receiving element. The at least two laser beams are focused on the receiving element by the focusing lens set and emitted through one of the plurality of branch elements. The plurality of expansion lens sets are disposed individually corresponding to the plurality of branch elements and configured for receiving the laser beam emitted from the one of the plurality of branch elements and further controlling the laser beam correspondingly to have a spread angle and an expanding angle. Each of the at least one beam receiving module includes a receiving lens set and a sensor set. The receiving lens set is configured for receiving laser beams reflected from the plurality of laser beams emitted by the plurality of expansion lens set. The sensor set is configured for receiving laser beams transmitted from the receiving lens set.

As stated, the light emission module and the wide angle scanning system provided in this disclosure, the beam steering element is utilized to control the positioning of the laser beam, and a plurality of branch elements of the imaging fiber bundle set are introduced to distribute and target the desired scanning directions, such that a wider scan angle and an adjustable scanned range can be obtained.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of a first embodiment of the wide angle scanning system in accordance with this disclosure;

FIG. 2 demonstrates schematically a spread angle and an expanding angle of FIG. 1;

FIG. 3 shows schematically an exemplary example of optical transmission in accordance with this disclosure;

FIG. 4 shows schematically an exemplary example of the imaging fiber bundle set in accordance with this disclosure;

FIG. 5 shows schematically a structure of the imaging fiber bundle set for a splitting operation in accordance with this disclosure;

FIG. 6 is a schematic view of a second embodiment of the wide angle scanning system in accordance with this disclosure;

FIG. 7 shows schematically an arrangement of the imaging fiber bundle set of FIG. 6; and

FIG. 8 is a schematic view of a third embodiment of the wide angle scanning system in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Embodiments listed below are described in detail with accompanying drawings, but these embodiments are not intended to limit the scope of the present disclosure. In addition, the accompanying drawings are for illustration purposes only and are not drawn according to the original dimensions. In order to facilitate understanding, the same components will be labeled with the same symbols in the following description.

Terms “include”, “have”, etc. mentioned in this disclosure are all open terms, which means simply “include but not limited to”.

In the description of different embodiments, when terms such as “first”, “second”, “third”, “fourth”, etc. are used to describe elements, they are only used to distinguish a plurality of elements from each other, and do not limit order or importance of these elements.

In the description of different embodiments, the so-called “couple” or “connect” may refer to two or more elements that are in direct physical or electrical contact with each other, or that are in indirect physical or electrical contact with each other, and may also refer to the mutual operation or action of two or more elements.

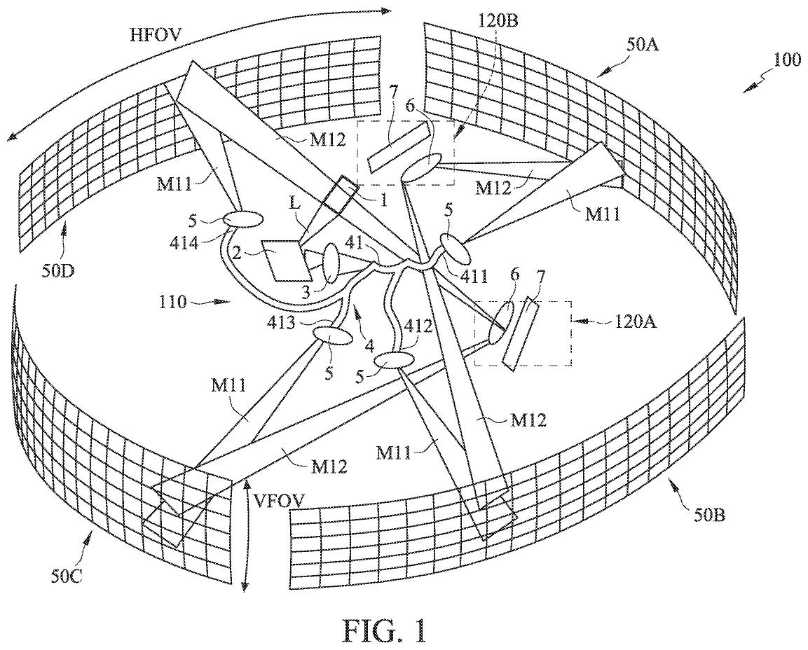

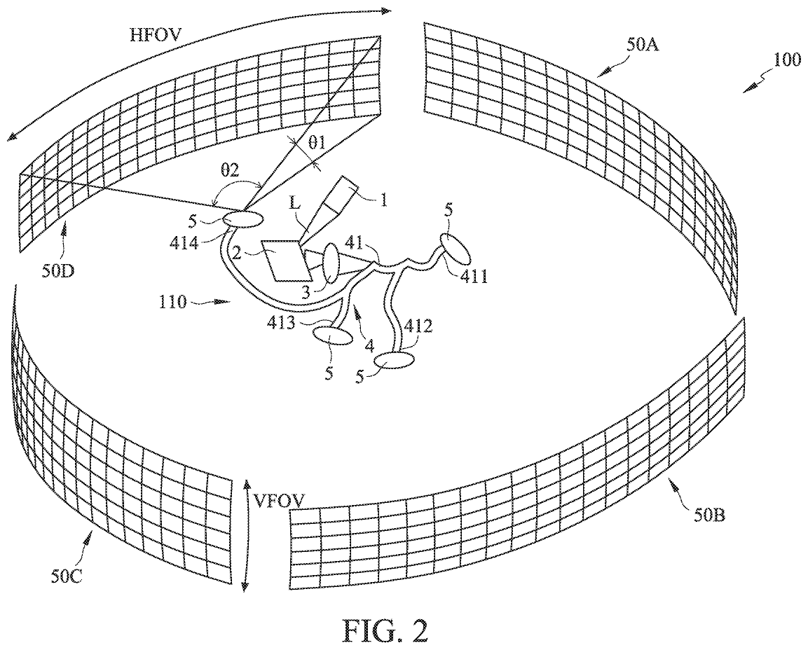

FIG. 1 is a schematic view of a first embodiment of the wide angle scanning system in accordance with this disclosure. FIG. 2 demonstrates schematically a spread angle and an expanding angle of FIG. 1. Referring to FIG. 1 and FIG. 2, the wide angle scanning system 100 includes at least a light emission module 110, a first beam receiving module 120A, and a second beam receiving module 120B.

In this embodiment, the light emission module 110 includes a laser source 1, a beam steering element 2, a focusing lens set 3, an imaging fiber bundle set 4, and four expansion lens sets 5. The laser source 1 is configured for emitting a laser beam L. According to this disclosure, the laser source 1 can be a fiber laser, such as a CW (Continuous wave) fiber laser, or a fiber laser or a laser diode that is furnished with adjustable pulse width and frequency, and the type of the laser source 1 can be also adjustable with respect to different scanned ranges or different optical elements. This disclosure does not provide any limitation to the wavelength of the laser beam L. However, in one embodiment, the wavelength of the laser beam is set within 900 nm˜1550 nm, where the 1550 nm is a safe wavelength to human eyes.

In this embodiment, the beam steering element 2 receives the laser beam L emitted from the laser source 1, and the beam steering element 2 would then split the laser beam L into at least two laser beams. In an embodiment not shown herein, a beam expander or reflector can be introduced between the beam steering element 2 and the laser source 1, such that a diameter of the laser beam L can be expanded, or a divergent angle thereof can be reduced.

The imaging fiber bundle set 4 includes a receiving element 41 and a first branch element 411, a second branch element 412, a third branch element 413 and a fourth branch element 414. The first branch element 411, the second branch element 412, the third branch element 413 and the fourth branch element 414 are individually connected to the receiving element 41 (particularly, at a common receiving end of the receiving element 41). As shown, the first branch element 411, the second branch element 412, the third branch element 413 and the fourth branch element 414 are four different emission ends of the receiving element 41, and forms a one-to-multiple imaging fiber bundle set 4. The number of the branch elements is determined according to desired scan angles. The focusing lens set 3 is disposed between the beam steering element 2 and the receiving element 41. The expansion lens sets 5 are individually disposed corresponding to positions of the first branch element 411, the second branch element 412, the third branch element 413 and the fourth branch element 414.

The focusing lens set 3 is configured for receiving the at least two laser beams L split by the beam steering element 2, and for controlling the at least two laser beams L to focus on the receiving element 41 of the imaging fiber bundle set 4. The laser beams L received by the receiving element 41 are individually emitted from the first branch element 411, the second branch element 412, the third branch element 413 and the fourth branch element 414. These expansion lens sets 5 receive correspondingly the laser beams M11 emitted from the first branch element 411, the second branch element 412, the third branch element 413 and the fourth branch element 414 of the imaging fiber bundle set 4 so as to generate a spread angle θ1 and an expanding angle θ2 in each of the scanned ranges 50A, 50B, 50C, 50D, respectively. In this embodiment, the spread angle θ1 is defined as an angle of the vertical scan direction VFOV in each of the scanned ranges 50A, 50B, 50C, 50D, and the expanding angle θ2 is defined as an angle of the horizontal scan direction HFOV in each of the scanned ranges 50A, 50B, 50C, 50D. Each of the spread angles θ1 and the corresponding expanding angle θ2 are controlled by the respective expansion lens set 5. In addition, the aforesaid spread angles θ1 are all together to define a vertical scan angle, and the aforesaid expanding angles θ2 are all together to define a horizontal scan angle. In this embodiment, the spread angle θ1 within the vertical scan direction VFOV would be greater than or equal to 60°, and the expanding angle θ2 within the horizontal scan direction HFOV would be greater than or equal to 90°.

Under such an arrangement, by utilizing a plurality of branch elements of the fiber bundle set 4 to distribute different positions within a desired space to be scanned, an angle eligible for scanning of a single laser source (such as the laser beam L of the laser source 1 or the beam steering element 2) can be expanded. That is, no more integration of multiple LiDAR sensors is required for providing the wide angle scanning.

The first branch element 411, the second branch element 412, the third branch element 413 and the fourth branch element 414 are purposely arranged to individual positions in the desired scan space so as to together define the vertical scan angle and the horizontal scan angle. For example, in one embodiment, the plurality of branch elements disposed separately along the vertical scan direction VFOV contribute their own spread angles θ1 to be accumulated as the vertical scan angle (herein, different spread angles θ1 responsible to individual branch elements are assumed no overlapping to each other). To the horizontal scan direction HFOV, these branch elements are disposed at the same position, such that the expanding angles θ2 corresponding to individual branch elements would be the same in the horizontal scan direction HFOV, and thus the same expanding angle θ2 corresponding to different branch elements would be integrally defined as the horizontal scan angle. In another embodiment, the plurality of branch elements are disposed on the same level surface but at different positions along the horizontal scan direction HFOV, and thus the horizontal scan angle (herein, different expanding angles θ2 responsible to individual branch elements are assumed no overlapping to each other) would be accumulated from different expanding angles θ2 corresponding to individual branch elements. In this embodiment, the spread angles θ1 of different branch elements are the same in the vertical scan direction VFOV, and thus the spread angle θ1 for each of the branch elements would be integrally defined as the vertical scan angle.

Referring to FIG. 1 and FIG. 2, the desired scanning direction for the first branch element 411 is the scanned range 50A, and the expanding angle θ2 and the spread angle θ1 of the first branch element 411 are 90° and 60°, respectively. Namely, the first branch element 411 is responsible for the scanned range 50A defined by a 0° ˜90° horizontal scan direction HFOV and a 0°˜60° vertical scan direction VFOV. The desired scanning direction for the second branch element 412 is the scanned range 50B, and the expanding angle θ2 and the spread angle θ1 of the second branch element 412 are 90° and 60°, respectively. Namely, the second branch element 412 is responsible for the scanned range 50B defined by a 90°˜180° horizontal scan direction HFOV and a 0°˜60° vertical scan direction VFOV. The desired scanning direction for the third branch element 413 is the scanned range 50C, and the expanding angle θ2 and the spread angle θ1 of the third branch element 413 are 90° and 60°, respectively. Namely, the third branch element 413 is responsible for the scanned range 50C defined by a 180°˜270° horizontal scan direction HFOV and a 0°˜60° vertical scan direction VFOV. The desired scanning direction for the fourth branch element 414 is the scanned range 50D, and the expanding angle θ2 and the spread angle θ1 of the fourth branch element 414 are 90° and 60°, respectively. Namely, the fourth branch element 414 is responsible for the scanned range 50D defined by a 270°˜360° horizontal scan direction HFOV and a 0°˜60° vertical scan direction VFOV. Thus, in this embodiment, the vertical scan angle of the light emission module 110 is 60° in the vertical scan direction VFOV and the horizontal scan angle of the light emission module 110 is 360° in the horizontal scan direction HFOV.

When one of the horizontal scan angle and the vertical scan angle is greater than 180°, the number of the beam receiving module may be greater or equal to two. Referring to FIG. 1, when two of the expanding angles θ2 are together to define the horizontal scan angle to be 180°, and while the horizontal scan direction HFOV is within 0° to 180°, the first beam receiving module 120A is arranged to receive and sense the laser beam M12 reflected from an object in the scanned ranges 50A, 50B. If the other two expanding angles θ2 are together to define the horizontal scan angle to be 180°, and while the horizontal scan direction HFOV is within 180° to 360°, the second beam receiving module 120B is arranged to receive and sense the laser beam M12 reflected from an object in the scanned ranges 50C, 50D.

In this disclosure, each of the first beam receiving module 120A and the second beam receiving module 120B includes a receiving lens set 6 and a sensor set 7. Each the receiving lens set 6 receives the laser beam M12 reflected from the laser beam M11 emitted by the expansion lens set 5, and the reflected laser beam M12 is further transmitted to the sensor set 7. The sensor set 7 receives the laser beam M12 from the receiving lens set 6, and then performs detection and analysis upon the laser beam M12.

In one embodiment, the receiving lens set 6 can be a beam splitter, a reflector, a lens or any combination of the aforementioned optical elements, and the sensor set 7 can be a SPAD (single-photon avalanche diode) sensor array, an APD (Avalanche photodiode) sensor array, or a CCD (Charge-coupled device) sensor array; but not limited thereto. In another embodiment not shown here, a polarizer can be disposed between the receiving lens set 6 and the sensor set 7. With this polarizer, any laser beam or light that is not returned from the scanned ranges 50A, 50B, 50C, 50D would be removed.

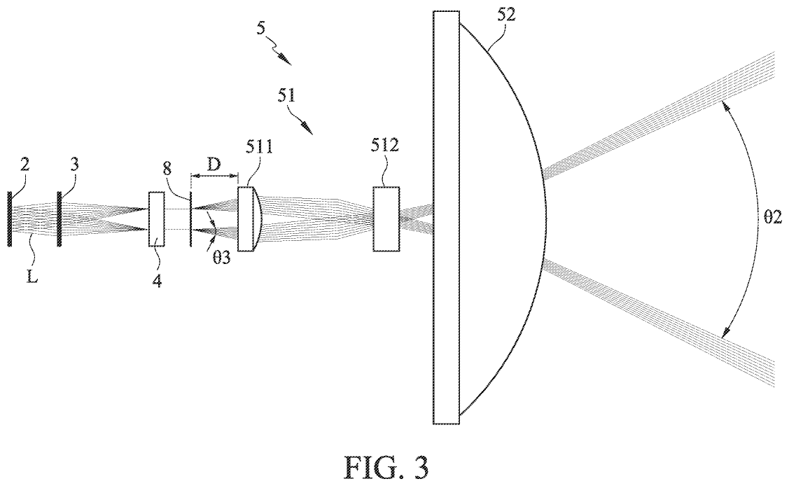

FIG. 3 shows schematically an exemplary example of optical transmission in accordance with this disclosure. Referring to FIG. 1 and FIG. 3, the beam steering element 2 includes a semi-solid beam diverter or a solid beam diverter. The semi-solid or solid beam diverter can be a spatial light module (SLM) configured for steering, diffracting and splitting the laser beam L into at least two laser beams L. In other words, the SLM is an optical component capable of modulating the amplitude and the phase of the incoming laser beam L. Namely, the SLM is configured for generating a diffraction pattern for beam steering of the laser beam L, controlling the switching of phase pattern, and controlling the dimension periods of the drawings. In addition, the SLM can evaluate practical situations to arrange a lens set with Fourier transform function. The semi-solid or solid beam diverter can be an LCoS (Liquid crystal on silicon) optical adjuster, or a beam steering element of a micro electromechanical system (MEMS); but not limited thereto.

In one embodiment, the semi-solid or solid beam diverter can be arranged to at least two divisions with different phases. With control upon beam's diameter and angle in each division, the beam steering element 2 would split the laser beam L into two laser beams, such that multiple light beams can be generated from a single light beam.

In this embodiment, the focusing lens set 3 is a lens set with Fourier transform function, and is configured for receiving the at least two laser beams L from the semi-solid or solid beam diverter, and further for performing a Fourier transform upon the at least two laser beams L for focusing the at least two lIn one embodiment, an aperture 8 is disposed between the beam steering element 2 and the focusing lens set 3. The aperture 8 is used for spatial filtering to remove zero-order noises or other redundant or unnecessary diffraction-level laser beams L, such as the laser beams L failed to be phase-modulated by the semi-solid or solid beam diverter. The scope of the aforesaid zero-order noises or other redundant or unnecessary diffraction-level laser beams L can be adjusted according to user needs.

### Laser Beams L.

In this embodiment, the expansion lens set 5 is a compound lens set. For example, the expansion lens set 5 can include a first lens 51 and a second lens 52. The combination of the first lens 51 and the second lens 52 can be a combination of a spherical lens and at least one aspherical lens set. The expansion lens set 5 can control the expanding angle θ2 between the laser beams L to be greater than 90°. In some other embodiments, the combination of the first lens 51 and the second lens 52 can be a combination of spherical lenses or aspherical lenses. Namely, the expansion lens set 5 is not limited thereto, but can be versatile formed according to specific needs.

Practically, FIG. 3 is a panoramic lens set based on the catadioptric principle. After passing orderly through the beam steering element 2 and the focusing lens set 3, the laser beams L would be focused on the aperture 8, and the laser beams L would leave the aperture 8 by presenting an opening angle θ3.

The first lens 51 can be a positive focal lens combination. The first lens 51 includes a condenser 511 and a divergent lens 512. The aperture 8 is separated to the condenser 511 by a distance D. After passing through the aperture 8, the laser beams L would be collected by the condenser 511 to generate the laser beam L. Then, with the divergent lens 512, the laser beam L can match the hole of the second lens 52, and thus the beam distribution of the laser beam L at the second lens 52 can be adjusted by the condenser 511 and the divergent lens 512.

The second lens 52 can be a combination of lenses with expanding focal lengths. Through adjusting the distance D, the opening angle θ3, and the beam distribution to the second lens 52 can be adjusted to regulate the expanding angle θ2 of the laser beam L. In this embodiment, the beam distribution includes a distance from the divergent lens 512 to the second lens 52, and a radius of the hole for the laser beam L to enter the second lens 52.

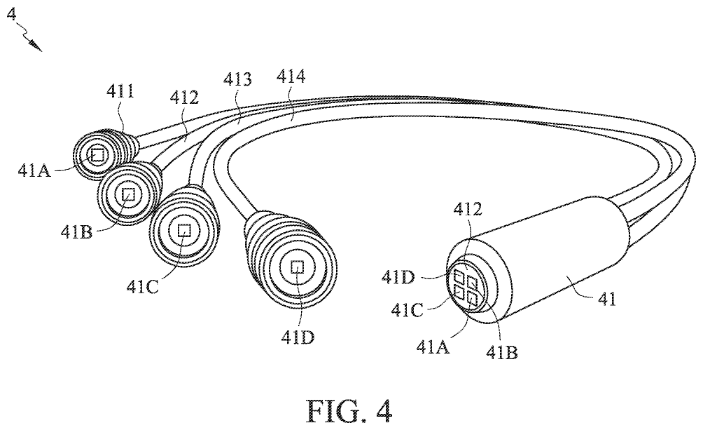

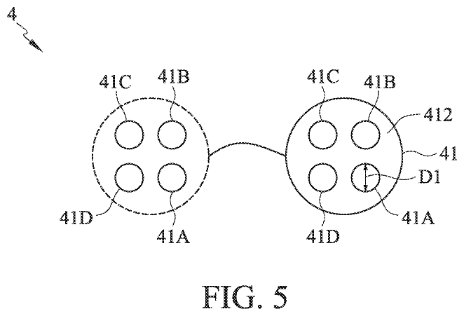

FIG. 4 shows schematically an exemplary example of the imaging fiber bundle set in accordance with this disclosure. FIG. 5 shows schematically a structure of the imaging fiber bundle set for a splitting operation in accordance with this disclosure. As shown, the receiving element 41 of the imaging fiber bundle set 4 is a receiving end, and the entrance plane 410 includes a first fiber bundle channel 41A, a second fiber bundle channel 41B, a third fiber bundle channel 41C, and a fourth fiber bundle channel 41D, in which the diameter D1 of the first fiber bundle channel 41A can be less than 2 mm, and the diameter of each of the second fiber bundle channel 41B, the third fiber bundle channel 41C and the fourth fiber bundle channel 41D can be equal to that of the first fiber bundle channel 41A. A number of the fiber bundle channels is equal to that of the branch elements. The pixel number of the first fiber bundle channel 41A, the second fiber bundle channel 41B, the third fiber bundle channel 41C or the fourth fiber bundle channel 41D can be greater than or equal to 128×128.

Positions of the first fiber bundle channel 41A, the second fiber bundle channel 41B, the third fiber bundle channel 41C and the fourth fiber bundle channel 41D are corresponding to those of the first branch element 411, the second branch element 412, the third branch element 413 and the fourth branch element 414. Namely, the fiber bundle channels of the imaging fiber bundle set 4 are arranged in a specific matrix arrangement with corresponding order. Thus, the imaging fiber bundle set 4 is an imaging fiber bundle set with one-to-multiple imaging type.

Upon such an arrangement, by inputting different phase images through the semi-solid or solid beam diverter in the beam steering element 2, the laser beam would be imaged in different areas of the entrance plane 410 of the receiving element 4. For example, the first fiber bundle channel 41A on the entrance plane 410 would be emitted from the exit of the first branch element 411. The single laser source 1 can utilize the beam steering element 2, the focusing lens set 3 and the imaging fiber bundle set 4 to achieve the purpose of wide-angle scanning.

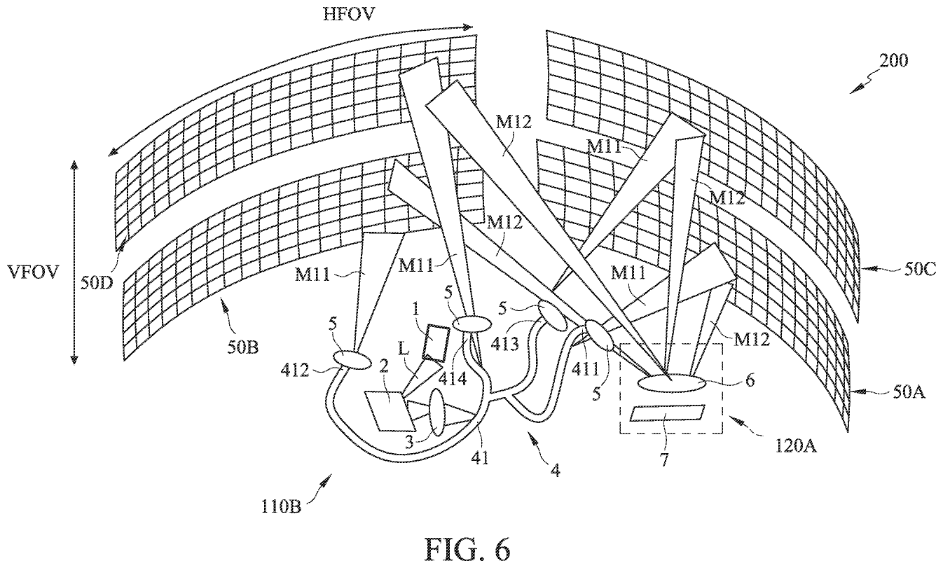

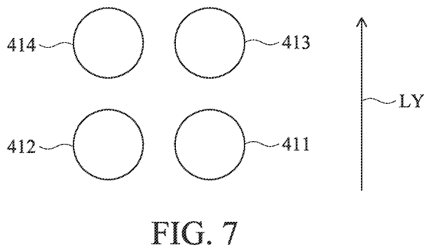

FIG. 6 is a schematic view of a second embodiment of the wide angle scanning system in accordance with this disclosure. FIG. 7 shows schematically an arrangement of the imaging fiber bundle set of FIG. 6. As shown, the light emission module 110B of the wide angle scanning system 200 is configured for scanning the scanned ranges 50A, 50B, 50C, 50D corresponding to different desired scanning directions. The horizontal scan angle on the horizontal scan direction HFOV is 180°, and thus a first beam receiving module 120A is arranged to receive and sense the reflected laser beams M12 from the scanned ranges 50A, 50B, 50C, 50D.

The first branch element 411, the second branch element 412, the third branch element 413 and the fourth branch element 414 of the imaging fiber bundle set 4 are distributed disposing in the desired scan spaces. The first branch element 411, the second branch element 412, the third branch element 413 and the fourth branch element 414 are and separated to each other by a distance. Along the vertical direction LY, the third branch element 413 is located above the first branch element 411, the fourth branch element 414 is located above the second branch element 412, and the third branch element 413 and the fourth branch element 414 are disposed on the same level plane and separated by a distance.

With the arrangement along the vertical direction LY, the desired scanning direction for the first branch element 411 is the scanned range 50A, and the expanding angle θ2 and the spread angle θ1 of the first branch element 411 are 90° and 90°, respectively. Namely, the first branch element 411 is responsible for the scanned range 50A defined by a 0°˜90° horizontal scan direction HFOV and a 0°˜90° vertical scan direction VFOV. The desired scanning direction for the second branch element 412 is the scanned range 50B, and the expanding angle θ2 and the spread angle θ1 of the second branch element 412 are 90° and 90°, respectively. Namely, the second branch element 412 is responsible for the scanned range 50B defined by a 90°˜180° horizontal scan direction HFOV and a 0°˜90° vertical scan direction VFOV. The desired scanning direction for the third branch element 413 is the scanned range 50C, and the expanding angle θ2 and the spread angle θ1 of the third branch element 413 are 90° and 90°, respectively. Namely, the third branch element 413 is responsible for the scanned range 50C defined by a 0°˜90° horizontal scan direction HFOV and a 90°˜180° vertical scan direction VFOV. The desired scanning direction for the fourth branch element 414 is the scanned range 50D, and the expanding angle θ2 and the spread angle θ1 of the fourth branch element 414 are 90° and 90°, respectively. Namely, the fourth branch element 414 is responsible for the scanned range 50D defined by a 90°˜180° horizontal scan direction HFOV and a 90°˜180° vertical scan direction VFOV. Thus, in this embodiment, the light emission module 110B has a 180° vertical scan angle in the vertical scan direction VFOV and a 180° horizontal scan angle in the horizontal scan direction HFOV. In other words, according to this disclosure, the arrangement of the plurality of branch elements of the imaging fiber bundle set 4 can be adjusted to arbitrarily define the scanned ranges.

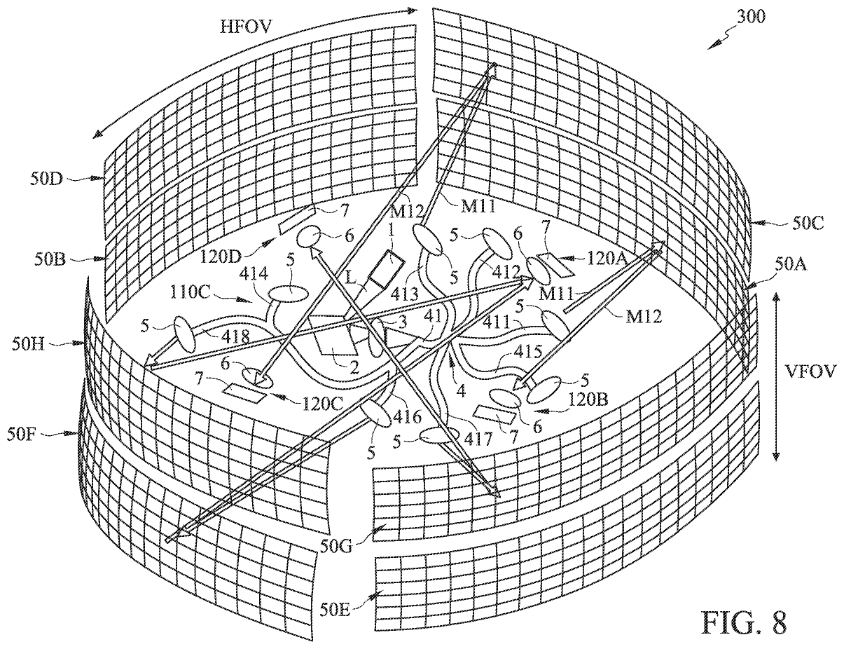

FIG. 8 is a schematic view of a third embodiment of the wide angle scanning system in accordance with this disclosure. For concise explanation of this embodiment, part of laser beams M11, M12 are illustrated in the drawing. As shown, a light emission module 110C of the wide angle scanning system 300 is configured for performing scanning upon scanned ranges 50A, 50B, 50C, 50D, 50E, 50F, 50G and 50H at corresponding desired scanning directions. The horizontal scan angle of the horizontal scan direction HFOV is 360°. A first beam receiving module 120A, a second beam receiving module 120B, a third beam receiving module 120C and a fourth beam receiving module 120D are applied to receive and sense the reflected laser beams M12 from scanned range 50A, 50B, 50C, 50D, 50E, 50F, 50G and 50H.

In this embodiment, the imaging fiber bundle set 4 includes 8 branch elements; a first branch element 411, a second branch element 412, a third branch element 413, a fourth branch element 414, a fifth branch element 415, a sixth branch element 416, a seventh branch element 417 and an eighth branch element 418, distributed disposing at different positions on the same or different levels. As shown, the desired scanning direction for the first branch element 411 is the scanned range 50A, and the expanding angle θ2 and the spread angle θ1 of the first branch element 411 are 90° and 90°, respectively. Namely, the first branch element 411 is responsible for the scanned range 50A defined by a 0°˜90° horizontal scan direction HFOV and a 0°˜90° vertical scan direction VFOV. The desired scanning direction for the second branch element 412 is the scanned range 50B, and the expanding angle θ2 and the spread angle θ1 of the second branch element 412 are 90° and 90°, respectively. Namely, the second branch element 412 is responsible for the scanned range 50B defined by a 0°˜90° horizontal scan direction HFOV and a 90°˜180° vertical scan direction VFOV. The desired scanning direction for the third branch element 413 is the scanned range 50C, and the expanding angle θ2 and the spread angle θ1 of the third branch element 413 are 90′ and 90°, respectively. Namely, the third branch element 413 is responsible for the scanned range 50C defined by a 90°˜180° horizontal scan direction HFOV and a 90°˜180° vertical scan direction VFOV. The desired scanning direction for the fourth branch element 414 is the scanned range 50D, and the expanding angle θ2 and the spread angle θ1 of the fourth branch element 414 are 90° and 90°, respectively. Namely, the fourth branch element 414 is responsible for the scanned range 50D defined by a 90°˜180° horizontal scan direction HFOV and a 0°˜90° vertical scan direction VFOV. The desired scanning direction for the fifth branch element 415 is the scanned range 50E, and the expanding angle θ2 and the spread angle θ1 of the fifth branch element 415 are 90° and 90°, respectively. Namely, the fifth branch element 415 is responsible for the scanned range 50E defined by a 270°˜360° horizontal scan direction HFOV and a 0° ˜90° vertical scan direction VFOV. The desired scanning direction for the sixth branch element 416 is the scanned range 50F, and the expanding angle θ2 and the spread angle θ1 of the sixth branch element 416 are 90° and 90°, respectively. Namely, the sixth branch element 416 is responsible for the scanned range 50F defined by a 180°˜270° horizontal scan direction HFOV and a 0°˜90° vertical scan direction VFOV. The desired scanning direction for the seventh branch element 417 is the scanned range 50G, and the expanding angle θ2 and the spread angle θ1 of the seventh branch element 413 are 90° and 90°, respectively. Namely, the seventh branch element 417 is responsible for the scanned range 50G defined by a 270°˜360° horizontal scan direction HFOV and a 90°˜1800 vertical scan direction VFOV. The desired scanning direction for the eighth branch element 418 is the scanned range 50H, and the expanding angle θ2 and the spread angle θ1 of the eighth branch element 418 are 90° and 90°, respectively. Namely, the eighth branch element 418 is responsible for the scanned range 50H defined by a 180°˜270° horizontal scan direction HFOV and a 90°˜180° vertical scan direction VFOV. Thus, in this embodiment, the light emission module 110C has a 360° vertical scan angle in the vertical scan direction VFOV and a 60° horizontal scan angle in the horizontal scan direction HFOV for achieving the wide angle scanning.

In summary, in the light emission module and the wide angle scanning system provided in this disclosure, the beam steering element is utilized to control the positions of the laser beams, and a plurality of branch elements of the imaging fiber bundle set are arranged to face individual desired scanning directions, such that the wide angle scanning can be achieved, and the scanned range can be adjusted.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A light emission module, comprising:
a laser source, configured for emitting a laser beam;
a beam steering element, configured for receiving the laser beam and further for splitting the laser beam into at least two laser beams;
a focusing lens set, configured for receiving the at least two laser beams split from the beam steering element;
an imaging fiber bundle set, including a receiving element and a plurality of branch elements, the plurality of branch elements being individually connected to the receiving element, distributed disposing, and oriented to individual desired scanning directions, wherein the focusing lens set is disposed between the beam steering element and the receiving element, the at least two laser beams are focused on the receiving element by the focusing lens set and emitted through one of the plurality of branch elements; and
a plurality of expansion lens sets, disposed individually corresponding to the plurality of branch elements, the plurality of expansion lens sets receiving the laser beams emitted from the plurality of branch elements and further controlling each of the laser beams correspondingly have a spread angle and an expanding angle.

2. The light emission module of claim 1, wherein a plurality of said spread angles corresponding to the plurality of branch elements integrally define a vertical scan angle, and a plurality of said expanding angles corresponding to the plurality of branch elements integrally define a horizontal scan angle.

3. The light emission module of claim 1, wherein the expanding angle is greater than 90°.

4. The light emission module of claim 1, wherein the spread angle is greater than 60°.

5. The light emission module of claim 1, wherein an entrance plane of the receiving element includes a plurality of optical fiber bundle channels disposed individually in correspondence to the plurality of branch elements.

6. The light emission module of claim 5, wherein the plurality of optical fiber bundle channels are arranged in an array manner.

7. The light emission module of claim 5, wherein each of the plurality of optical fiber bundle channels has a diameter less than 2 mm.

8. The light emission module of claim 1, wherein the beam steering element includes a semi-solid or solid beam diverter, the focusing lens set is a lens set with Fourier transformation function, the semi-solid or solid beam diverter is configured for steering and diffracting the laser beam to be split into the at least two laser beams, the lens set with Fourier transformation function is configured to receive the at least two laser beams from the semi-solid or solid beam diverter and further perform a Fourier transform upon the at least two laser beams so as to focus the at least two laser beams.

9. The light emission module of claim 1, wherein the laser source is an optical fiber laser.

10. The light emission module of claim 1, wherein the expansion lens set is a compound lens set.

11. A wide angle scanning system, comprising:
a light emission module, including:
a laser source, configured for emitting a laser beam;
a beam steering element, configured for receiving the laser beam and further for splitting the laser beam into at least two laser beams;
a focusing lens set, configured for receiving the at least two laser beams split from the beam steering element;
an imaging fiber bundle set, including a receiving element and a plurality of branch elements, the plurality of branch elements being individually connected to the receiving element, distributed disposing, and oriented to individual desired scanning directions, wherein the focusing lens set is disposed between the beam steering element and the receiving element, the at least two laser beams are focused on the receiving element by the focusing lens set and emitted through one of the plurality of branch elements; and
a plurality of expansion lens sets, disposed individually corresponding to the plurality of branch elements, the plurality of expansion lens sets receiving the laser beam emitted from the plurality of branch elements and further controlling each of the laser beams correspondingly have a spread angle and an expanding angle; and
at least one beam receiving module, each of the at least one beam receiving module including:
a receiving lens set, configured for receiving laser beams reflected from the plurality of laser beams emitted by the plurality of expansion lens set; and
a sensor set, configured for receiving laser beams transmitted from the receiving lens set.

12. The wide angle scanning system of claim 11, wherein the expanding angle is greater than 90°.

13. The wide angle scanning system of claim 12, wherein the plurality of spread angles integrally define a vertical scan angle, and the plurality of expanding angles integrally define a horizontal scan angle; wherein, when one of the horizontal scan angle and the vertical scan angle is greater than 180°, a number of the at least one beam receiving module is greater than or equal to two.

14. The wide angle scanning system of claim 11, wherein the spread angle is greater than 60°.

15. The wide angle scanning system of claim 11, wherein an entrance plane of the receiving element includes a plurality of optical fiber bundle channels disposed individually in correspondence to the plurality of branch elements.

16. The wide angle scanning system of claim 15, wherein the plurality of optical fiber bundle channels are arranged in an array manner.

17. The wide angle scanning system of claim 15, herein each of the plurality of optical fiber bundle channels has a diameter less than 2 mm.

18. The wide angle scanning system of claim 11, wherein the beam steering element includes a semi-solid or solid beam diverter, the focusing lens set is a lens set with Fourier transformation function, the semi-solid or solid beam diverter is configured for steering and diffracting the laser beam to be split into the at least two laser beams, the lens set with Fourier transformation function is configured to receive the at least two laser beams from the semi-solid or solid beam diverter and further perform a Fourier transform upon the at least two laser beams so as to focus the at least two laser beams.

19. The wide angle scanning system of claim 11, wherein the laser source is an optical fiber laser.

20. The wide angle scanning system of claim 11, wherein the expansion lens set is a compound lens set.
